(19) United States
(12) Patent Application Publication
(10) Pub. No.: US 2021/0329852 A1
(43) Pub. Date: Oct. 28, 2021

(54) METHOD FOR PREVENTING A FORMATION OF, AND/OR FOR DISPERSING, A TROPICAL CYCLONE, AND ARRANGEMENT THEREFOR

(71) Applicant: Gerd Specht, Stralsund (DE)

(72) Inventor: Gerd Specht, Stralsund (DE)

(21) Appl. No.: 17/239,258

(22) Filed: Apr. 23, 2021

(30) Foreign Application Priority Data
Apr. 23, 2020 (DE) 10 2020 111 068.5

(51) Int. Cl. A01G 15/00; B64D 1/12; F42B 10/56

(52) U.S. Cl. CPC A01G 15/00; F25D 3/14; F42B 10/56; B64D 1/12

(57) ABSTRACT

A method and an arrangement for preventing a formation of a hurricane storm and/or dispersing a tropical cyclone storm defining an eye are disclosed. The arrangement is dropped from an aircraft into water in the eye of the storm and includes at least first and second vessels filled with a refrigerant. The first and second vessels are pressure resistant, spherical and sinkable with the first vessel having a first sinking velocity and the second vessel having a second sinking velocity. The first sinking velocity is greater than the second. The first and second vessels have respective first and second opening mechanisms for releasing the refrigerant at pregiven respective depths. The first opening mechanism is configured to open at a first depth and the second opening mechanism is configured to open at a second depth. The first depth is greater than the second depth.

### CROSS REFERENCE TO RELATED APPLICATION

This application claims priority of German patent application no. 10 2020 111 068.5, filed Apr. 23, 2020, the entire content of which is incorporated herein by reference.

### TECHNICAL FIELD

The disclosure relates to a method for preventing a formation and/or an expansion of tropical cyclones which form over the sea, for example of hurricanes, typhoons and/or cyclones, and to an arrangement therefor.

### BACKGROUND

A tropical cyclone is a low-pressure system. It normally forms only in the tropics or the subtropics. Owing to the Coriolis force, a tropical cyclone rotates in a cyclonic manner. This rotation is at the same time the cause of the typically spiral-shaped cloud bands of such storms. The wind speed of a tropical cyclone can reach over 300 km/h. Tropical cyclones can extend over hundreds of kilometers in diameter.

Hurricanes form on the surface of oceans at latitudes of between 5° and 8° if the following conditions are met: a surface temperature of the ocean above 26° C. to a depth of approximately 50 meters, sufficient humidity in the troposphere (that region of the Earth's atmosphere which extends from the Earth's surface to an altitude of 10 to 15 km), wind uniform or absent at all altitudes, and the presence of a tropical low-pressure area.

These conditions are most commonly encountered in tropical areas. The hurricane then forms owing to the evaporation of surface water, whereby a low-pressure area forms at the sea surface and, at high altitude, a cloud mass forms that promotes the development of thunderstorms.

The Coriolis effect deflects liquid flows by generating a vortex, the direction of rotation of which is dependent on the position of the hurricane relative to the equator: a hurricane rotates counterclockwise in the northern hemisphere and clockwise in the southern hemisphere.

If the tropical storm rotates quickly enough, an eye can form. The eye is a relatively cloud-free, almost windless region in the center of rotation, in which cold dry air sinks from above. The eye is surrounded by cumulus clouds extending to high altitude, the eyewall. The tropical cyclone attains the highest wind speeds in this region.

A weakening of the tropical cyclone occurs only when the region with the most favorable conditions is departed from, for example upon contact with land, contact with cold water or dry air masses.

Tropical cyclones are among the natural events that can escalate into natural hazards if people, nature and material assets are threatened. The effects of wind and rain can cause severe destruction. This arises firstly owing to the mechanical force of the wind itself, secondly owing to the sustained intense precipitation, and thirdly owing to storm flooding. Here, a tropical cyclone, owing to its large spatial extent and slow tracking progression, often rages at one location for several hours. The strong wind, in particular in the direct vicinity of the eye, poses a risk in particular to shipping in maritime areas and, on land, directly owing to the wind force or indirectly as a result of objects being picked up and carried, can cause damage to even buildings of solid construction and to vehicles or trees.

Tropical cyclones have different names depending on where they form. For example, the term “hurricane” is used in the North Atlantic and in the North-East Pacific, whereas the same phenomenon is referred to as “typhoon” in South-East Asia and as “cyclone” in other ocean basins. Below, the expression “hurricane” will be used representatively for all tropical cyclones.

The prior art has disclosed methods which are intended to prevent a formation of large tropical cyclones.

For example, the document DE 1 200 603 discloses methods for preventing storm damage. The content of the patent specification relates to disrupting the equilibrium of moving air masses and, by changing the equilibrium conditions, dispersing clusters before their kinetic energy leads to severe damage. Here, it is sought to achieve this by virtue of cartridges filled with basic and acidic substances being introduced into the air masses of a cyclone.

The document WO 2019/186019 A1 relates to a submarine module for dissipating the energy of a hurricane, in order to weaken it, by removing the order established during its formation in order to downgrade it to a tropical storm, and to a method for dissipating the energy of a hurricane by means of one or more modules.

The document US 2009/0173386 A1 relates to the field of changing water temperatures and to dissolved and particulate substances in bodies of water such as oceans, seas and rivers, to structures that can assist in changing and controlling such surface and underground water temperatures and compositions, and to many applications and methods for the production and use thereof. The description also relates generally to the field of structures for changing the weather conditions for the generation and/or the maintenance of a hurricane and/or of hurricane-type weather in the vicinity of a hurricane. It is disadvantageous here that the attempts to prevent a hurricane are carried out locally at certain locations in the ocean. A targeted prevention of the expansion of a hurricane at the location of its formation is not possible.

### SUMMARY

It is therefore an object of the invention to eliminate the disadvantages of the prior art and to provide a method which prevents or inhibits a formation or expansion of a tropical cyclone. Furthermore, an arrangement is provided for carrying out a method which prevents or inhibits a formation or expansion of a tropical cyclone.

According to various embodiments, a method according to the disclosure for preventing a formation of a hurricane and/or for dispersing a tropical cyclone with an eye has the following method steps:
a. filling at least two vessels, with a first vessel and a second vessel, with a refrigerant,
b. loading the at least two filled vessels into at least one aircraft,
c. positioning the at least one aircraft over the eye of the tropical cyclone and/or in the immediate vicinity of the tropical cyclone,
d. dropping the at least two filled vessels into the eye of the tropical cyclone and/or into the immediate vicinity of the tropical cyclone, such that the at least two filled vessels plunge into underlying water directly at the location of the eye and/or such that the at least two filled vessels plunge into water in the immediate vicinity of the tropical cyclone, wherein the vessels are configured so as to be of pressure-resistant, spherical and sinkable form, wherein a first sinking speed V1 of the first vessel B1 is greater than a second sinking speed V2 of the second vessel B2,
e. opening the at least two vessels B and releasing the refrigerant K at a predefined depth in the water, wherein a first opening depth O1 of the first vessel B1 is greater than a second opening depth O2 of the second vessel B2.

As a result of the introduction of refrigerants into different depths (O1, O2) of the ocean, cooling of the water occurs at relatively great depths. In this way, an upward movement of the cold water from the depths of the ocean to the surface is accelerated through utilization of the anomaly of the water. The anomaly of the water has the effect that water with a temperature of 4° C. has the greatest density and therefore sinks downward. The deeper water masses, which are colder, thus rise upward, as the uppermost water layer.

According to various embodiments, the at least two vessels B are slowed during freefall by means of a parachute F in order to prevent destruction of the at least two vessels B upon impact against the water.

According to various embodiments, the at least two vessels B are connected to one another by a connecting means. The connecting means may for example be a chain or a belt. Further connecting elements are conceivable. Upon impact against the water, the at least two vessels are separated from one another in order to ensure sinking into the water independently of the weight of the other vessel.

According to various embodiments, the at least two vessels B are opened by means of pressure switches in order to release the refrigerant K in the water.

Furthermore, loading of the aircraft should preferably be performed taking into consideration the opening depth O, such that the vessels do not obstruct one another in the sinking state. An arrangement as follows is preferably to be prioritized: the first vessel B1 with the greatest sinking speed V1 is loaded into the aircraft last, the vessel B2 with the slowest sinking speed V2 is loaded into the aircraft first, such that, during a dropping operation, the vessel B1 with the greater sinking speed plunges into the water first and sinks fastest and to the greatest depth. A transposition of the two vessels could lead to a collision of the vessels in the water.

The vessels B are preferably dimensioned in accordance with the Stokes equation, such that required sinking speeds V and required opening depths O can be calculated. The Stokes equation, which is based on Stokes' Law, serves for the calculation of the sinking speed of spherical bodies in a liquid.

According to one embodiment, multiple aircraft are used in order to be to drop more vessels with refrigerant. The effect of the cooling of the water masses is hereby intensified.

A wireless transmission of measured values to an evaluation unit, which is arranged at least one remote station, for example on land, on a ship, on an aircraft carrier, aircraft or the like, is preferably performed. With new mobile radio standards, such as for example 5G, a mobile radio network can be established with multiple stations, for example with multiple aircraft, even on high seas. It is thus possible for radio networks to be operated temporarily over a larger area and also over a longer period of time. The measured values are recorded directly at the at least two vessels B and/or at the connecting means. In this way, it is intended to achieve that valuable information is collected and evaluated in order to be able to better understand the phenomenon of tropical cyclones, or the effect of the generation of tropical cyclones or the effect of the change of the temperature in the water. In this way, errors or findings regarding flight behavior, triggering behavior, sinking behavior or the like can be identified.

The measured-value unit is preferably configured such that, once the immersion depth has been reached, the measured-value unit is decoupled from the vessel. Preferably, the measured-value unit has a lower density than water and/or the measured-value unit has buoyancy aids such that the measured-value unit passes to the water surface. In this way, a transmission of the measured data to the evaluation unit is made possible even after the immersion in the water.

According to one embodiment, communication between the at least two vessels B is also conceivable.

Preferably, in method step c), the at least one aircraft is positioned in front of the eye of the tropical cyclone in the tracking direction in order to compensate for a time delay between the release of the at least two filled vessels from the aircraft and the opening at the predefined water depth and a rising of the cold water. Here, the positioning is dependent on the tracking speed of the hurricane. In the case of an incorrectly assumed tracking speed, a resulting incorrect positioning of the aircraft and the dropping of the vessels can have the result that the vessels do not land in the water under the eye but instead pass into the inner wall of the eye of the tropical cyclone.

The object is also achieved by an arrangement for preventing a formation of a hurricane and/or for dispersing a tropical cyclone (with an eye). According to various embodiments, the arrangement is geared toward being dropped from an aircraft, for example from airplanes, into water, wherein the device is dropped through the eye of the tropical cyclone and/or into the water in the immediate vicinity of the tropical cyclone. According to various embodiments, the arrangement has the following components: at least two vessels B, with a first vessel B1 and a second vessel B2, and a refrigerant, wherein the at least two vessels B are filled with the refrigerant.

The vessels are configured so as to be of pressure-resistant, spherical and sinkable form, wherein a first sinking speed V1 of the first vessel B1 is greater than a second sinking speed V2 of the second vessel B2. The at least two vessels B furthermore have an opening mechanism. This has the effect that the vessels are opened at a predefined depth (immersion depth) in order to allow a release of the refrigerant at the predefined depth. A first opening depth of the first vessel B1 is in this case greater than a second opening depth of the second vessel B2. The pressure resistance of the at least two vessels must be configured such that the vessels are pressure-resistant as far as the above-defined immersion depth.

According to various embodiments, the arrangement has a parachute which is configured to slow the device during freefall in order to prevent destruction of the at least two vessels B upon plunging into the water. It is conceivable here for the parachute to be arranged in one of the vessels and for the parachute to be triggered during freefall. Triggering, for example by compressed air, may furthermore be performed for example on the basis of pressure measurement values and/or speed measurement values. Other triggering mechanisms are conceivable.

According to various embodiments, the at least two vessels B are connected to one another by a connecting means 4 which is of releasable configuration such that the at least two vessels B are separated from one another upon impact against the water. The connecting means 4 are preferably formed from flexible and/or a lightweight material, such as for example high-strength synthetic ropes.

According to various embodiments, the at least two vessels B each have at least one pressure switch. Here, the pressure switches are configured to open the vessels B1 or B2 in order to release the refrigerant K. Preferably, the vessels B are opened at a predefined depth or in the presence of a predefined pressure. For this, too, the arrangement of a measurement unit on the vessels and/or the device is conceivable.

The at least two vessels are preferably dimensioned differently from one another such that they have mutually different sinking speeds and/or immersion depths, wherein a first sinking speed and/or a first immersion depth of the first vessel B1 is greater than a second sinking speed and/or a second immersion depth of the second vessel B2. It is hereby achieved that the vessels sink into the depth of the ocean at different speeds.

According to various embodiments, the arrangement furthermore has a sensor unit for recording measured values, wherein the measured values are recorded directly at the at least two vessels B and/or at the connecting means and/or at the device.

The arrangement may have a wireless transmission unit and/or communication unit for transmitting the measured values to an evaluation unit and/or for communication between the at least two vessels B.

According to various embodiments, the refrigerant is dry ice.

According to various embodiments, the material of the at least two vessels is preferably steel. Use of other materials that have the required characteristics, such as for example pressure resistance, cold resistance or the like, is conceivable. It is furthermore conceivable for the vessel to have a core in order to achieve a required overall density. The core may for example have granite.

An advantage of the method according to the disclosure and of the device according to the disclosure is that, directly at the location of the formation or further development of the tropical cyclone, the warm water masses at the surface of the ocean are cooled. Using simple and inexpensive means, physical laws are set in motion: by means of a uniform introduction of refrigerants over an area into different depths of the ocean, cooling of the water situated at a greater depth occurs. This sets in motion an upward movement of the cold water from the depths of the ocean to the surface, by virtue of the anomaly of the water being utilized. The anomaly of the water has the effect that water with a temperature of 4° C. has the greatest density. The deeper water masses, which are colder, thus rise upward, as the uppermost water layer. During a formation of hurricanes, the uppermost water layer has at least a temperature of 26° C. By means of the cooling of the water masses in deeper layers, mixing of the water masses occurs. The consequence is that the expansion of the hurricane is hindered, because the warm uppermost water layer is displaced by cold water. As a result, it is no longer the case that warm humidified air rises upward, and the drive of the hurricane, so to speak, is thus lost.

It is furthermore advantageous that dry ice is easy to produce. With corresponding protective measures and/or storage facilities, it can also be stored over a relatively long period of time. In this way, a reserve can be provided such that action can be taken quickly when a hurricane is forming. For this situation, a fleet of airplanes should also be on standby in order to allow action to be taken quickly.

Through observation of the warming of the sea surface, for example by means of satellite images, it is possible on the basis of the detected temperature profile for centers of formation to be localized at an early point in time. Action can thus be taken even more quickly by virtue of the fact that steps can be taken against a formation and/or expansion of a tropical cyclone at a very early point in time via the method according to the disclosure and/or the device according to the disclosure.

### BRIEF DESCRIPTION OF THE DRAWINGS

The invention will now be described with reference to the drawings wherein:

FIG. 1 schematically shows a construction of the arrangement according to the disclosure;

FIG. 2 schematically shows a construction of a vessel B; and,

FIG. 3 schematically shows a configuration of the dropping strategy in the case of multiple aircraft being used.

### DESCRIPTION OF THE PREFERRED EMBODIMENTS

The description refers to the appended drawings in which, for illustrative purposes, specific embodiments are shown in which the arrangement according to the disclosure can be implemented. In this regard, directional terminology such as for example “up”, “down”, et cetera, are used with regard to the orientation of the described drawings. The directional terminology serves for illustrative purposes and is in no way limiting.

It is self-evident that other embodiments may be used, and structural or logical changes made, without departing from the scope of the present disclosure. It is self-evident that the features of the various embodiments described herein may be combined with one another unless specifically stated otherwise. The following detailed description is therefore not to be regarded in a limiting sense.

In the context of this description, the expressions “connected”, “attached” and “coupled” are used to describe both a direct and an indirect connection (for example ohmic and/or electrically conductive, for example in an electrically conductive connection), a direct or indirect attachment, and a direct or indirect coupling.

In the figures, identical or similar elements are denoted by identical reference designations where expedient.

According to various embodiments, the expression “coupled” or “coupling” may be understood in the sense of a mechanical, hydrostatic, thermal and/or electrical connection. According to various embodiments, “linked” may be understood in the sense of a mechanical (physical) coupling. A link may be configured to transmit a mechanical interaction (for example force, torque).

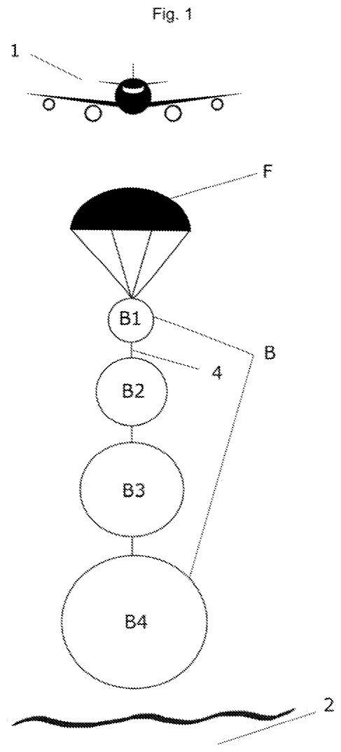

FIG. 1 illustrates an arrangement according to the disclosure for preventing a formation of a hurricane and/or for dispersing a tropical cyclone with an eye. The device is configured to be dropped from an aircraft 1 into water 2 into the eye 3 of a tropical cyclone (not illustrated here) and/or into water 2 in the immediate vicinity of the tropical cyclone. The arrangement has the following components: at least two vessels B, with a first vessel B1 and a second vessel B2, and a refrigerant K (FIG. 1 illustrates a device with four vessels). The at least two vessels B are filled with the refrigerant K. The vessels are configured so as to be of pressure-resistant, spherical, cold-resistant and sinkable form, wherein a first sinking speed V1 of the first vessel B1 is greater than a second sinking speed V2 of the second vessel B2. Furthermore, in the case of the at least two vessels B, there is arranged in each case one opening mechanism 8 for the release of the refrigerant K at a predefined depth, wherein a first opening depth O1 of the first vessel B1 is greater than a second opening depth O2 of the second vessel B2.

The arrangement according to the disclosure may furthermore have a parachute F which is configured to slow the device during freefall in order to prevent destruction of the at least two vessels B upon impact against the water.

According to various embodiments, the at least two vessels B are connected to one another by a connecting means 4. The connecting means 4 is of releasable configured such that the at least two vessels B are separated from one another (not illustrated here) upon impact against the water 2.

The connecting means 4 may be configured in the form of a chain or of multiple chains (not illustrated here).

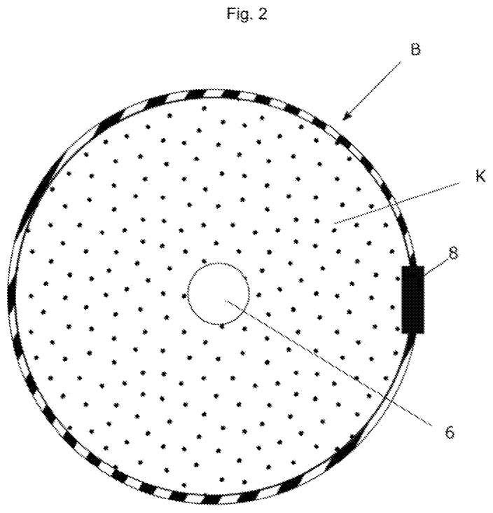

As illustrated in FIG. 2, according to various embodiments, the at least two vessels B are each equipped with at least one opening mechanism 8, for example in the form of pressure switches, which are configured to open the vessels B1 or B2, in order to release the refrigerant K, at a predefined depth and/or in the presence of a predefined ambient pressure. Furthermore, FIG. 2 illustrates a construction of a vessel B according to various embodiments. Other variants of the configuration of the vessels are however conceivable. According to various embodiments, a vessel B has a casing which is preferably manufactured from steel. The casing of the vessel B encompasses a cavity which accommodates the refrigerant K. The vessels B are dimensioned so as to be of different size and/or weight depending on the selected immersion depth T. In order to achieve correct dimensioning, the vessel B may have a core 6 which is manufactured for example from graphite.

Preferably, the at least two vessels B are dimensioned differently than one another such that they have mutually different sinking speeds V and/or immersion depths T, wherein a first sinking speed V1 and/or a first immersion depth T1 of the first vessel B1 is greater than a second sinking speed V2 and/or a second immersion depth T2 of the second vessel B2.

Furthermore, the arrangement has a sensor unit for recording measured values, which are recorded directly at the at least two vessels B and/or at the connecting means 4.

Furthermore, the arrangement has a wireless transmission unit and/or a communication unit for transmitting the measured values to an evaluation unit and/or for communication between the at least two vessels B.

The refrigerant K is preferably dry ice. It may for example be in the form of cubes or circular disks stacked one on top of the other in the vessels B.

The material of the at least two vessels B is preferably steel.

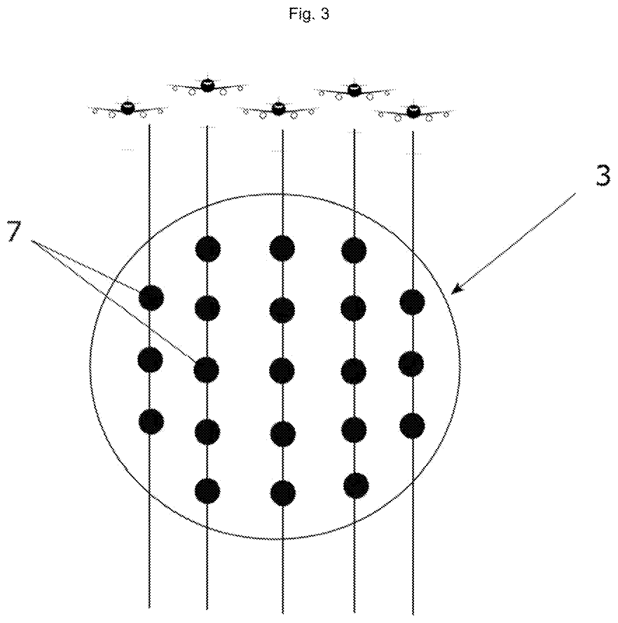

FIG. 3 shows a possible dropping plan with possible dropping points 7 of the device over the eye 3 of a developing hurricane. Here, multiple aircraft 1, for example in the form of a fleet of airplanes, as illustrated here, may be used, wherein the airplanes fly adjacent to one another in parallel, with a certain spacing to one another, over the eye 3 and, in so doing, drop the devices at various dropping points 7. This assumes that the aircraft 1 are large enough to be able to accommodate and transport multiple, for example five, devices in their interior.

It is understood that the foregoing description is that of the preferred embodiments of the invention and that various changes and modifications may be made thereto without departing from the spirit and scope of the invention as defined in the appended claims.

### REFERENCE DESIGNATIONS

1 Aircraft
2 Water
3 Eye
4 Connecting means
6 Core
7 Dropping point
8 Opening mechanism/pressure switch
B Vessel
B1 First vessel
B2 Second vessel
K Refrigerant
F Parachute
V Sinking speed
V1 Sinking speed of the first vessel B1
V2 Sinking speed of the second vessel B2
T Immersion depth
T1 Immersion depth of the first vessel B1
T2 Immersion depth of the second vessel B2
O Opening depth
O1 Opening depth of the first vessel B1

What is claimed is:

1. A method for preventing a formation of a hurricane storm and/or dispersing a tropical cyclone storm, the storm defining an eye and the method comprising the steps of:
providing at least first and second vessels configured to be pressure resistant, spherical and sinkable with said first vessel having a first sinking velocity V1 and said second vessel having a second sinking velocity V2 lower than said first sinking velocity V1;
filling said first and second vessels with a refrigerant;
loading said first and second vessels into at least one aircraft;
positioning said at least one aircraft over the eye of the storm and/or in direct proximity of said storm;
dropping said first and second vessels loaded with said refrigerant directly whereat the eye of said storm is located and/or in direct proximity of said storm so as to permit said first vessel and said second vessel to plunge into water lying under said storm and/or so as to permit said first vessel and said second vessel to plunge into water in direct proximity of said storm; and,
opening said first and second vessels and releasing said refrigerant at a predefined depth in the water wherein a depth of opening of said first vessel is greater than a depth of opening of said second vessel.

2. The method of claim 1, wherein said first and second vessels are slowed by a parachute while descending to prevent a destruction of said first and second vessels when plunging into the water.

3. The method of claim 1, wherein said first and second vessels are connected via a connector to each other and disconnected from each other upon impact with the water.

4. The method of claim 1, wherein said first and second vessels have respective pressure switches configured to respectively open said first and second vessels to release said refrigerant.

5. The method of claim 1, wherein a loading of said aircraft is conducted while considering the opening depth.

6. The method of claim 1, wherein said first and second vessels are dimensioned in accordance with Stokes equation.

7. The method of claim 1, wherein several drops per flight of said aircraft are conducted.

8. The method of claim 1, wherein several aircraft are used in order to drop off said first and second vessels.

9. The method of claim 1, wherein a wireless transmission of measured values to an evaluation unit is conducted; and, said evaluation unit is accommodated on said first and second vessels and/or on a connector mutually connecting said first and second vessels.

10. An arrangement for preventing a formation of a hurricane storm and/or dispersing a tropical cyclone storm defining an eye, the arrangement being configured to be dropped from an aircraft into water in the eye of the storm and/or in direct proximity of said storm, said arrangement comprising:
at least first and second vessels;
a refrigerant;
said first and second vessels being filled with said refrigerant;
said first and second vessels being configured to be pressure resistant, spherical and sinkable with said first vessel having a first sinking velocity V1 and said second vessel having a second sinking velocity V2 and said first sinking velocity V1 being greater than said second sinking velocity V2;
said first and second vessels having respective first and second opening mechanisms for releasing said refrigerant at pregiven respective depths;
said first opening mechanism of said first vessel being configured to open at a first depth and said second opening mechanism of said second vessel being configured to open at a second depth; and,
said first depth being greater than said second depth.

11. The arrangement of claim 10, further comprising a parachute configured to slow a free fall of said arrangement to prevent destruction of said first and second vessels when plunging into the water.

12. The arrangement of claim 11, further comprising a connector connecting said first and second vessels to each other; and, said connector being configured to be releasable so as to permit said first and second vessels to mutually separate upon plunging into the water.

13. The arrangement of claim 12, wherein said connector is made of flexible and/or light material.

14. The arrangement of claim 10, wherein said first and second vessels have respective pressure switches configured to respectively open said first and second vessels to release said refrigerant.

15. The arrangement of claim 10, wherein said first and second vessels are configured differently from each other so as to cause said first and second vessels to have first and second sink velocities different from each other and/or respective plunge depths different from each other; and, wherein said first sink velocity and/or a first plunge depth of said first vessel is greater than said second sink velocity and/or a second plunge depth of said second vessel.

16. The arrangement of claim 12, further comprising a sensor unit for recording measured values directly on said first and second vessels and/or on said connector.

17. The arrangement of claim 16, further comprising a wireless transmitter unit and/or a communications unit for transmitting said measured values to an evaluation unit and/or for communication between said first and second vessels.

18. The arrangement of claim 10, wherein said refrigerant is dry ice.

19. The arrangement of claim 10, wherein said first and second vessels are made of steel.
